(19) United States
(12) Patent Application Publication
(10) Pub. No.: US 2021/0240897 A1
(43) Pub. Date: Aug. 5, 2021

(54) SYSTEM AND METHOD FOR CAPTURING HARDWARE EMULATION DATA

(71) Applicant: Synopsys, Inc., Mountain View, CA (US)

(72) Inventor: Beshara Elmufdi, Mountain View, CA (US)

(21) Appl. No.: 17/163,157

(22) Filed: Jan. 29, 2021

Related U.S. Application Data
(60) Provisional application No. 62/968,546, filed on Jan. 31, 2020.

(51) Int. Cl. G06F 30/3312

(52) U.S. Cl. CPC G06F 30/3312; G06F 2119/12

(57) ABSTRACT

A method of storing data during verification of a circuit design by a hardware emulation system, includes, in part, receiving, once in every N emulation clock cycles, P sets of register data each set including M register bits associated with the circuit design. The M register bits of each set in P shift registers are stored during M cycles of a capture clock. The stored bits are shifted out during M*P cycles of the capture clock, where (M+1)*P is less than or equal to N.

### RELATED APPLICATION

The present application claims benefit under 35 USC 119(e) of U.S. Application Ser. No. 62/968,546 filed Jan. 31, 2020, entitled “Detecting Timing Violations In Emulation Using FPGA Reprogramming”, the content of which is incorporated herein by reference in its entirety.

### TECHNICAL FIELD

The present disclosure relates to a hardware emulation system, and more particularly to storage of data in such a system.

### BACKGROUND

A hardware emulation system is adapted to debug and verify the functionality of a circuit being designed by forming an emulation model of the circuit through programming of the programmable devices disposed in the emulation system. The emulation model is representative of the circuit being designed and is often described in a hardware description language (e.g. Verilog) that is compiled into a format used by the emulation system.

A hardware emulation system includes a number of hardware and software components which together define the behavior of the emulation model and the circuit being verified and/or designed. One implementation of a hardware emulation system uses configurable hardware such as Field-Programmable Gate Arrays (FPGA). An FPGA is an integrated circuit designed to be programmed by a designer after its manufacture and at the field. An FPGA contains an array of programmable logic blocks, memory blocks and a hierarchy of reconfigurable interconnects that enable the realization of the design under development.

In an emulation system, the user is interested in performing two basic actions, namely (i) to run the design before the device hardware implementation is available or completed, and (ii) obtain information about the design to determine if the design operates as intended and complies with the required specifications, such as power and speed.

A key requirement for obtaining information about the design is the ability to probe the design signals. The probing involves gathering the state of some or all design signals in the emulation system as it is run, and presenting them to the user in a format that is relatively easy to interpret, such as a set of waveforms.

### SUMMARY

In accordance with one embodiment of the present disclosure, a method of storing data during verification of a circuit design by a hardware emulation system, includes, in part, receiving, once in every N emulation clock cycles, P sets of register data each set including M register bits associated with the circuit design. The method further includes, in part, storing the M register bits of each set in P shift registers during M cycles of a capture clock, and shifting out the stored bits during M*P cycles of the capture clock, where (M+1)*P is less than or equal to N.

In accordance with one embodiment of the present disclosure, a non-transitory computer readable medium includes stored instructions, which when executed by a processor, cause the processor to receive, once in every N emulation clock cycles, P sets of register data each set including M register bits associated with the circuit design. The instructions further cause the processor to store the M register bits of each set in P shift registers during M cycles of a capture clock. The instructions further cause the processor to shift out the stored bits during M*P cycles of the capture clock, where (M+1)*P is less than or equal to N.

A circuit, in accordance with one embodiment of the present disclosure, includes, in part P shift registers each configured to receive, once in every N emulation clock cycles, P sets of register data each set comprising M register bits. Each of the P shift registers is further configured to store the M register bits during M cycles of a capture clock, and shift out the stored bits during M*P cycles of the capture clock, where (M+1)*P is less than or equal to N.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 shows snapshot data as well as primary data being captured in accordance with one embodiment of the present disclosure.

FIG. 2 is a flowchart for data capture and reconstruction, in accordance with one embodiment of the present disclosure.

FIG. 3 is a simplified block diagram of an example of a snapshot capture logic, in accordance with one aspect of the present disclosure.

FIG. 4 is a simplified high-level block diagram of a snapshot based recording engine, in accordance with one embodiment of the present disclosure.

FIG. 5 is a simplified block diagram of a snapshot capture logic, in accordance with another embodiment of the present disclosure.

FIG. 6 is a block diagram of the data collection and control logic of FIG. 4, in accordance with one embodiment of the present disclosure.

FIG. 7 shows a flowchart of various processes used during the design and manufacture of an integrated circuit, in accordance with some embodiments of the present disclosure.

FIG. 8 shows a diagram of an example of an emulation system in accordance with some embodiments of the present disclosure.

FIG. 9 shows a diagram of an example of a computer system in which embodiments of the present disclosure may operate.

### DETAILED DESCRIPTION

An FPGA-based emulation platform often includes data capture blocks and/or intellectual property (IP) blocks that are used to capture information about the design undergoing emulation and to present the information to the user. Such IPs, however, have limited capability. There are generally two types of IPs, namely fast capture and slow capture. Fast capture IPs do not affect the design performance but are generally limited in the number of signals they can capture before their performance degrades. Slow capture IPS can capture all signals in the design, thereby causing the emulated design to run slower.

Signal capture should not induce clock jitter which happens in systems that stop and start the design clocks in order to capture the data. Jitter may happen, for example, when the data capture IP cannot store all captured data within one emulation clock cycle.

One approach for performing signal capture is based on scan chains in which scan elements use a register along with a 2-input multiplexer (mux) feeding the input of the register. The mux and register pairs are configured in a chain where the output of each register is applied to the input of the mux of the next register—i.e., the next element in the scan chain. The other input of each mux is driven by a register or the design signal being captured.

Current scan based signal capture techniques are slow because the time it takes to shift the data out of the scan chain can be relatively long. Given that modem FPGAs may contain millions of logic elements and registers, copying and shifting out all the data in every clock cycle may severely degrade the performance of the emulation system.

A signal capture method and system, in accordance with one embodiment of the present disclosure, is fast and does not slow down the emulation speed. In one embodiment, all the signals in the design may be captured, thereby providing for the coverage of all the design blocks without imposing unnecessary preconditions or limits. In another embodiment, a smaller set of data may be captured to reduce the time it takes to shift the data out of the scan chain. A first order reduction is accomplished by capturing only register outputs. The combinational logic signal outputs may then be reconstructed/recomputed from outputs of the registers using a software tool.

In accordance with one embodiment, the signal capture time is reduced by using a clock that is faster than the emulation clock to shift out the data. For example, if the emulation clock cycle frequency is N and the clock frequency applied to the scan chain (also referred to herein as the capture clock) is 100*N, then 100 bits of data may be shifted out in every emulation clock cycle, without adversely affecting the emulation speed.

To avoid degrading the emulation clock frequency while facilitating the relatively large number of bits that need to be shifted out, in accordance with one embodiment of the present disclosure, data may be shifted out over multiple emulation clock cycles. In one embodiment, the register values (also referred to herein as snapshot data) associated with a design are captured once every N emulation clock cycles. Primary input (PI) data, such as inputs received from external sources or software blocks that are in communication with the DUT, associated with a design are captured during one or more cycles of each N emulation clock cycles.

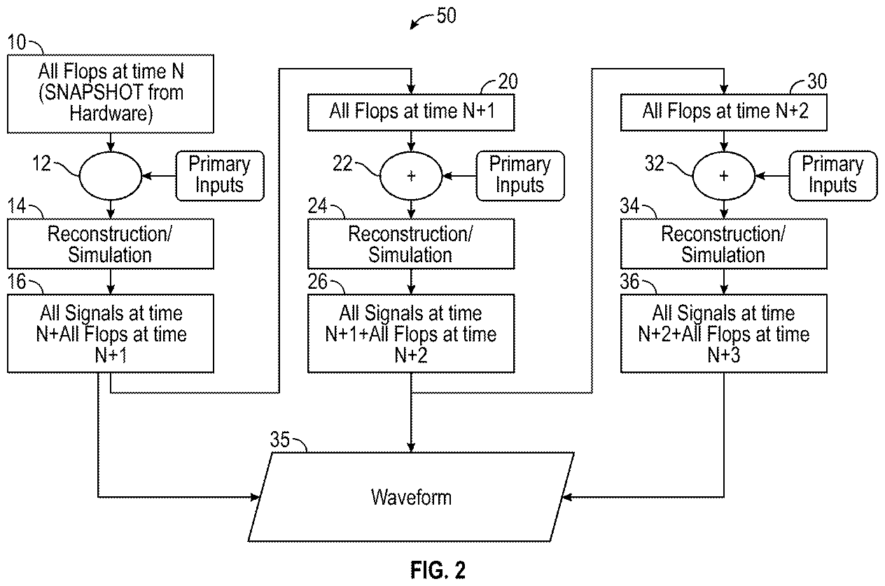

As described further below, during the hardware emulation of a design, the snapshot data as well as the PI data are captured and stored in a storage medium. The stored data is subsequently processed by a software simulation tool for presentation to a user in waveforms or other formats, as described below with reference to FIG. 2. In order to process the stored data, the software simulation tool (also referred to herein as software simulator) simulates a copy of the design emulated by the hardware emulation. Moreover, as a part of the handshake between the hardware emulator and the software simulator, the data stored in the storage medium conforms to a predefined protocol and format that is understood and recognized by the software simulator to enable the software simulator to properly identify each signal whose data is stored. For example, the address in which a signal is stored in the storage medium may be used by the software simulator to properly identify that signal. In another embodiment, the signal name may be used by the software simulator as an identifier of the signal. The software simulator simulates the design using the data retrieved from the storage medium to reconstruct data associated with all intervening cycles, as described further below.

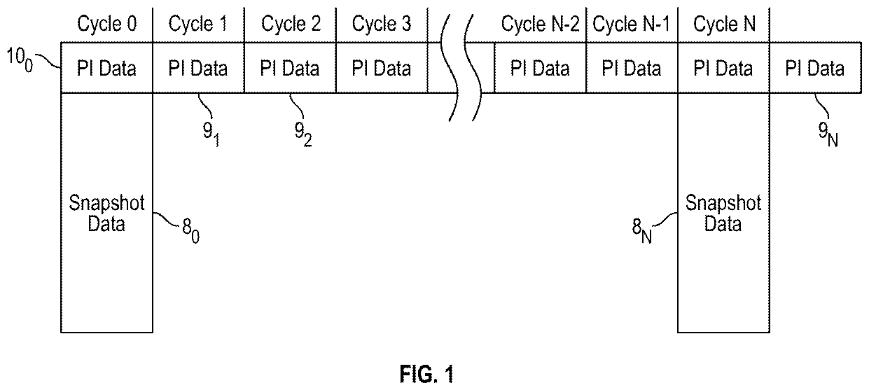

FIG. 1 shows snapshot data 8₀, 8_{N} . . . being captured once every N emulation clock cycles (e.g., cycles 0, N . . . ), and PI data 9₀, 9₁ . . . 9_{N} being captured during every emulation clock cycle by a hardware emulation tool. Although FIG. 1 shows that PI data is captured during every emulation cycle, it is understood that in other embodiments, the PI data may be captured during only a subset of each N emulation cycles As described above, in accordance with one aspect of the present disclosure, the value of every signal in the design for all N cycles may be reconstructed (computed) by a software simulator tool so as to generate a continuous waveform.

FIG. 2 is a flowchart 50 associated with data capture and reconstruction by a software simulation tool, in accordance with one embodiment of the present disclosure. At 10, snapshot data associated with emulation cycle N is captured by a hardware emulation tool. At 12, the PI data associated with cycle N is captured by the hardware emulation tool. At 14, cycle N combinational logic values are computed/constructed from the PI and snapshot data by a software simulation tool that performs a logic simulation of the circuit that was hardware emulated. The combinational logic values so computed are then used at 16 to determine all cycle N+1 registers values. For each register, cycle N+1 output value of the register is the same as cycle N input value to the register. The input value to each register in cycle N is determined by the combinational logic connected to the input terminal of the register. The software simulation tool computes the output values of the combinational logic applied to the input terminal of each register.

The combinational logic values computed at 14 and register values determined at 16 are used at 35 to display the waveforms. The data capture process then continues in a similar manner, where the computed/reconstructed register data associated with emulation cycle N+1 is received at 20 and combined with captured cycle N+1 PI data at 22 to reconstruct/compute cycle N+1 combinational logic values at 24. At 26, the registers values associated with cycle N+2 are determined. The combinational logic values computed at 24 together with register values determined at 26 are used at 35 to display the waveforms. Similarly, the snapshot data associated with emulation cycle N+2 is received at 30 and combined with cycle N+2 PI data received at 32 to reconstruct cycle N+2 combinational logic values at 34. At 36, the registers values associated with cycle N+2 are determined. The combinational logic values computed at 34 together with the register values determined at 36 are used at 35 to display the waveforms. The process is then repeated for subsequent cycles until the next snapshot data is captured at cycle 2N. An EDA software tool called VCS, which is commercially available from Synopsys, Inc. of Mountain View, Calif. may be used at to reconstruct/compute the combinational logic values at 14, 24, and 34.

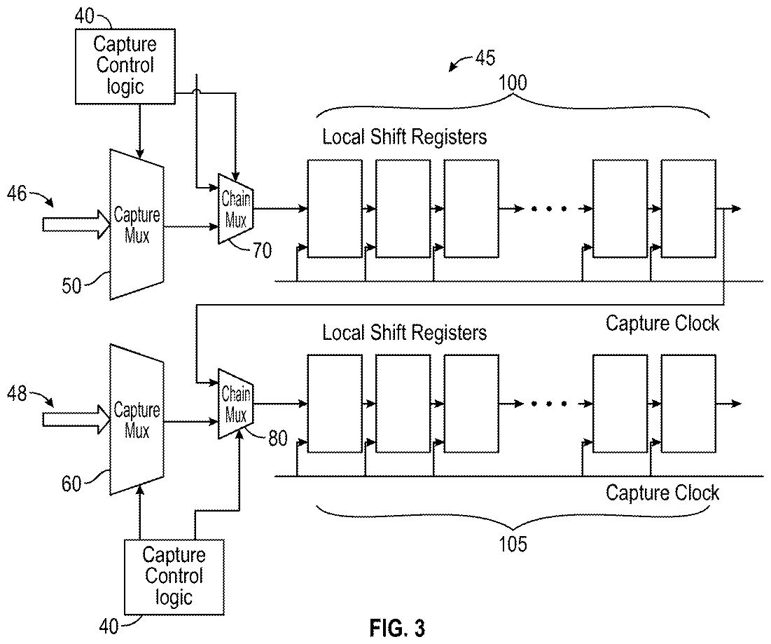

FIG. 3 is a simplified block diagram of an example of a snapshot capture and transfer out logic 45 (hereinafter alternatively referred as snapshot capture logic), in accordance with one aspect of the present disclosure. Snapshot capture logic 45 is shown as receiving 32-bit register data 46 and 48 at capture muxes 50 and 60 respectively in parallel. Although snapshot capture logic 45 is shown as receiving data from a pair of registers supplying their data to muxes 50 and 60, it is understood that in other embodiments data from any number of registers may be received in parallel by a snapshot capture logic. Moreover, although snapshot capture logic 45 is shown as being configured to receive and store 32-bit data, it is understood that in other embodiments, snapshot capture logic 45 may be configured to receive data having any number of bits, 16, 32, 64 or otherwise.

Snapshot capture logic 45 is also shown as including, in part, capture control logic 40, chain muxes 70, 80, and 32-bit shift registers 100, 105. During the capture/copy mode, shift registers 100, 105 store incoming data in response to transitions of a capture clock. During the transfer out mode, data stored in shift registers 100, 105 is shifted out serially and one-bit at a time using the capture clock, also described further below.

While in the capture mode, during each cycle of the capture clock, one bit of the 32-bit data 46 is delivered from capture mux 50 and chain mux 70 and stored in shift register 100. Accordingly, after 32 cycles of the capture clock, all 32 bits of data 46 are stored in shift register 100. In a similar manner, after 32 cycles of the capture clock, all 32 bits of data 48 are stored in shift register 105.

During the transfer out mode, the data stored in shift registers 100, 105 is shifted serially and stored in memory 108. As shown in FIG. 3, the output of shift register 100 is coupled to the input of shift register 105 via chain mux 80 to form a scan chain. Therefore, after 64 capture clock cycles, the 64 bits of data stored in shift register 100 and 105 are transferred and stored in a data collection and control logic described below. Accordingly, if there are 32 capture clock cycles in one emulation cycle, it takes one emulation cycle to store the register data in the shift registers 100, 105, and two emulation cycles to transfer the data stored in shift registers 100, 105. Therefore, the data stored in the shift registers of a snapshot capture logic, in accordance with one aspect of the present disclosure, is stored and transferred out over a multitude of emulation cycles so as to match the transfer speed of the register output data to the speed of the storage device, such as a memory device, thereby advantageously relaxing the data transfer requirements. In one embodiment, the scan chain length may be dynamically varied.

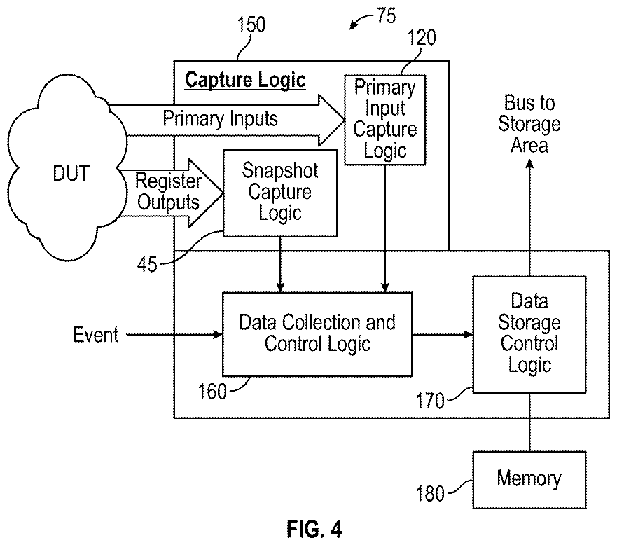

FIG. 4 is a simplified high-level block diagram of a hardware emulation data capture logic 75, in accordance with one embodiment of the present disclosure. Snapshot capture logic 45 is configured to capture register data and serially transfer out the stored data, as described in detail above with references to FIGS. 2 and 4. The data transferred by snapshot capture logic 45 is received by data collection and control logic 160.

Primary input capture logic 120 is configured to capture the primary input data during every emulation clock cycle, as described above with reference to FIG. 1, and transfer the captured data to data collection and control logic 160. In one embodiment, primary input capture logic 120 may use logic blocks similar to those shown in FIG. 3. However, a relatively shorter chain of scan registers may be required to capture and transfer out the captured primary. In another embodiment, a set of multiplexers coupled to a memory may be used to store and transfer out the primary data.

Data collection and control logic 160 is configured to combine the data received from snapshot control logic 45 and primary input control logic 120, and transfer the combined data to data control logic 170. Signal Event-applied to data collection and control logic 160—indicates whether the data being delivered to data collection and control logic 160 is or is not of interest to a user. Data storage control logic 170 is configured to format and store the data received from data collection and control logic 160 in memory 180. Memory 180 may be a local memory, or a remote storage disposed on another storage hardware. Memory 180 may be a dual-port memory to enable storage of the data from a first port, and a concurrent retrieval of the data from a second port.

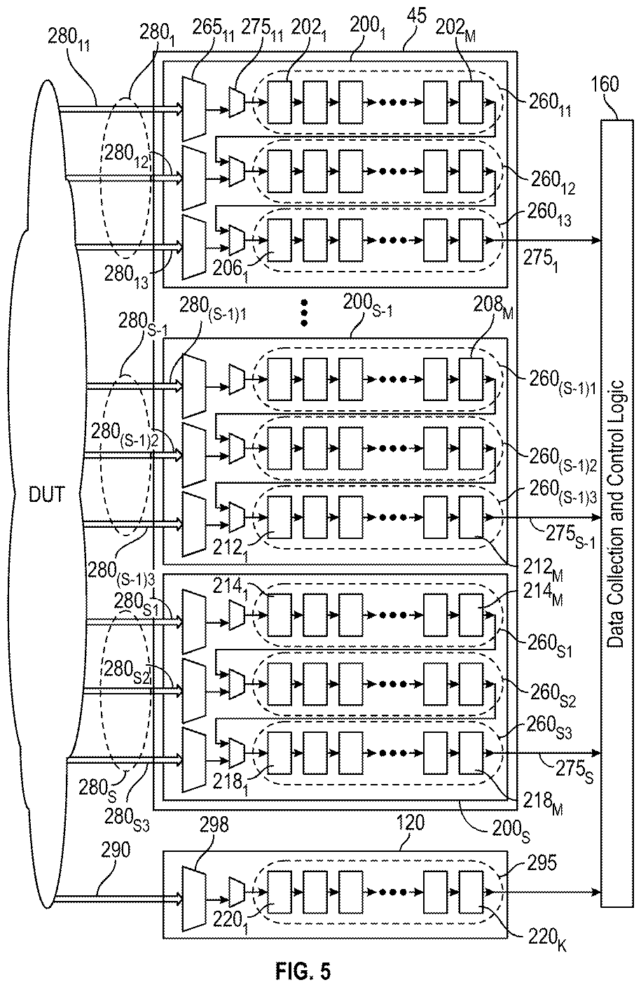

FIG. 5 is a simplified logic block diagram of a snapshot capture logic 45, in accordance with another embodiment of the present disclosure. DUT 300 is shown as supplying S groups of register data 280₁ . . . 280_{(S-1)}, 280_{S} to snapshot capture logic 45. Each of the S groups is shown as including 3 sets of register data each having M-bits. For example, data group 280₁ is shown as including register data sets 280₁₁, 280₁₂, and 280₁₃. Similarly, data group 280_{S} is shown as including register data sets 280_{S1}, 280_{S2}, and 280_{S3}. As described above, each register data set 280₁₁, 280₁₂, 280₁₃ . . . 280_{(S-1)1}, 280_{(S-1)2}, 280_{(S-1)3}, 280_{S1}, 280_{S2}, 280_{S3} is shown as including M-bits.

Snapshot capture logic 45 is shown as including, in part, S register groups, namely register groups 200₁ . . . 200_{(S-1)}, 200_{S} each having 3 sets of M-bit registers configured to form a scan chain. For example, register group 200₁ is shown as including 3 sets of M-bit registers 260₁₁, 260₁₂ and 260₁₃. Likewise, register group 200s is shown as including 3 sets of M-bit registers 260_{S1}, 260_{S2} and 260_{S3}. Register set 260₁₁ is shown as including registers 202₁ . . . 202_{M}, and register set 260₁₃ is shown as including registers 206₁ . . . 206_{M}. 260₁₂. In a similar manner, register set 260_{S1} is shown as including registers 214₁ . . . 214_{M}, and register set 260_{S3} is shown as including registers 218₁ . . . 218_{M}. Each register set is shown as being configured as a shift register.

As described above, register set 260₁₁, 260₁₂ and 260₁₃, collectively form register group 200₁, and register set 260_{S1}, 260_{S2} and 260_{S3} collectively form register group 200_{S}. Data from each register group is shown as being delivered to data collection and control logic 160. For example, register group 260₁ is shown as delivering data 275₁ to data collection and control logic 160, and register group 260_{S} is shown as delivering data 275_{S} to data collection and control logic 160. The registers in all register sets are driven by the capture clock which operates at a higher frequency than the emulation clock.

As described above, during each capture clock cycle, one bit of data from each data set is delivered and stored in an associated register set. Accordingly, for example, during each capture clock cycle one bit of data set 280₁₁ is stored in register set 260₁₁, one bit of data set 280₁₂ is stored in register set 260₁₂, one bit of data set 280_{S1} is stored in register set 260_{S1}; and one bit of data set 280_{S3} is stored in register set 260_{S3}. In other words, each data set is loaded into its associated register set in parallel. Therefore, after M cycles of the capture clock, all 3*M*S data bits in data groups 280₁ . . . 280_{(S-1)} and 280_{S} are loaded and stored in the registers disposed in capture control logic 45. Because the registers in each register group are configured as a shift register, after another 3*M cycles of capture clock, all data bits stored in capture control logic 45 are transferred to data collection and control logic 160 via output data 275₁ . . . 275_{(S-1)}, and 275_{S}. Therefore, for the example shown in FIG. 5, if the capture clock is configured to have a frequency that is 4M times the frequency of the emulation/DUT cycle, during each emulation cycle, data from all data groups may be loaded in parallel to capture control logic 45 and shifted out serially to data collection and control logic 160.

Associated with each register set is a capture mux and a chain mux via which the data from the associated data set is received. For example, data from data set 280₁₁ is delivered to register set 260₁₁ via capture mux 2651 and chain mux 275₁₁. Similarly, for example, data from data set 280_{S3} is delivered to register set 260_{S3} via capture mux 265_{S3} and chain mux 275_{S3}.

Snapshot capture logic 45 is also shown as including, in part, primary input capture logic 120 shown as receiving PI data 290 via mux 298. The PI data is stored in K-bit register 295, and delivered to data collection and control logic 160. The K-bit register 295 (shown as including K registers 220₁ . . . 220_{K}) is also driven by the capture clock. Accordingly, the PI data is captured in K cycles of the capture clock, and transferred to data collection and control logic 160 in another K cycles of the capture clock. In some embodiments, K is smaller than M.

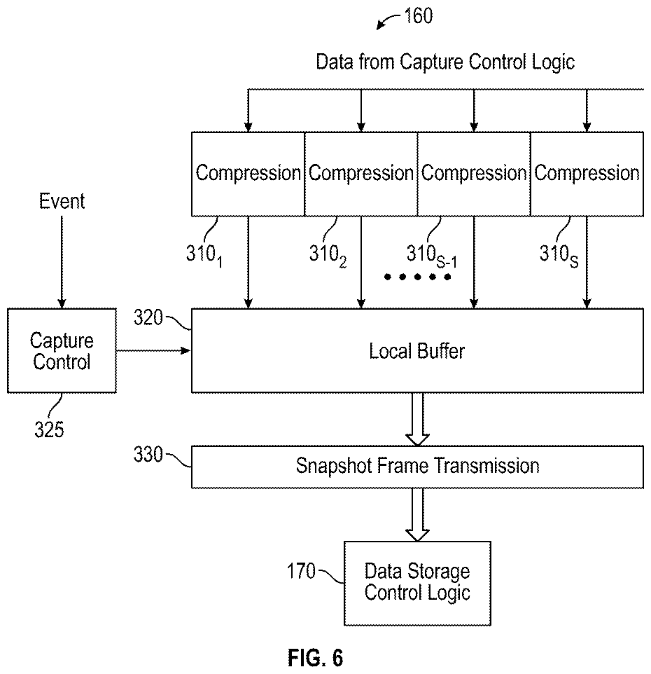

FIG. 6 is a more detailed view of the data collection and control logic 160 of FIG. 4. Data collection and control logic 160 is shown as including, in part, S optional compression blocks 310₁, 310₂ . . . 310_{S-1}, 310_{S} each associated with and adapted to receive data from a different one of the S data outputs 275₁, 275₂ . . . 275_{S-1}, 275_{S} of the snap capture logic shown in FIG. 5. Data collection and control logic 160 is also shown as including, in part, a local buffer 320 adapted to store data received either directly from the snapshot capture logic, or alternatively from compression blocks 310₁ . . . 310_{S-1}, 310_{S}, as shown. In one embodiment, snapshot frame transmission block 330 is configured to receive the data stored in local buffer 320, place the received data in frames, add header information to the frames, such as the number of bits stored in each frame, and deliver the frames to data storage control logic 170. Capture control block 325 is configured to mark the data store in local buffer 320 as data that is of interest or data that is not of interest in response to signal Event. Data marked as of interest (alternatively referred to herein as “interesting” data) is placed in fames as described above. Data marked as being not of interest (alternatively referred to herein as “not interesting” data) may be stored or discarded per predefined policy. Each frame includes snapshot data and PI data from N emulation cycles, where N is an integer equal to or greater than one.

As described above, data received from the capture control logic is optionally compressed to reduce the size of the snapshot data frames. Any compression scheme, such as, for example, Huffman encoding, Lempel-Ziv, LZMA, Shannon coding, and the like may be used for compressing the data.

Local buffer 320 is adapted to mark the received data as either snapshot data or PI data to differentiate between the two so as facilitate software data reconstruction, as described above. Marking of data may be achieved either with a bit marker, by bit position or by an index. In one embodiment, the data stored in local buffer 320 may be split into sub-frames rather than full frames to enable faster streaming of the data into data storage control logic 170.

Determination as to which data is “interesting” or “not interesting” may change from one emulation model run to another emulation model run. In one embodiment, as described above, such determination is indicated using the signal Event. Signal Event trigger mechanism may be simple or complex such that it can flag “interesting” and “not interesting” data based on simple or complex settings and algorithms.

As described above with reference to FIG. 4, data storage control logic 170 is configured to direct the data received from the data collection and control logic 160 to a location where the data will be stored. Data storage control logic 170 may convert the received data into a form that will match the requirements of the medium in which the data is stored. Data storage control logic 170 is further configure to maintain information about the location of where the data is stored for later processing. Such storage mediums include (i) local memories such as internal FPGA memories, (ii) external memories such as commercial DDR or SRAM memories that can be connected to the FPGA, or (iii) remote memory on another system.

For all storage mediums, the available storage bandwidth (the rate at which data can be stored) matches the rate at which the data collection and control logic supplies the data to be stored. In one embodiment, the storage medium has a high bandwidth and high capacity to avoid data loss, and further to facilitate storage of a large amount of snapshot frames. In one example, a dual-data rate (DDR) memory connected to a field-programmable gate array (FPGA) provides a good balance between the storage bandwidth (e.g., over 100 Gbps) and storage capacity (e.g., multiple Gigabytes of data).

Embodiments of the present disclosure may be modified to handle situations in which storage capacity is limited. In one embodiment, the emulation may be stopped to copy the stored data into a larger storage such as in a hierarchical cache. For example, if the snapshot frame data are being stored in an external DDR memory, when the DDR memory is full, the snapshot based recording engine may stop the emulation so that the stored data can be read from the DDR memory and written to a bulk storage, such as a large disk array. Once all the data is copied to the bulk storage, the DDR content is erased and the emulation can resume. In another embodiment, the data may overwritten via a circular buffer scheme. Accordingly, once the storage is full, the oldest data is overwritten by the newest data so that only the newest data is maintained. It is then up to the user to stop the data capture. When the data capture has stopped, the user will have up to the maximum storage size worth of the newest data available.

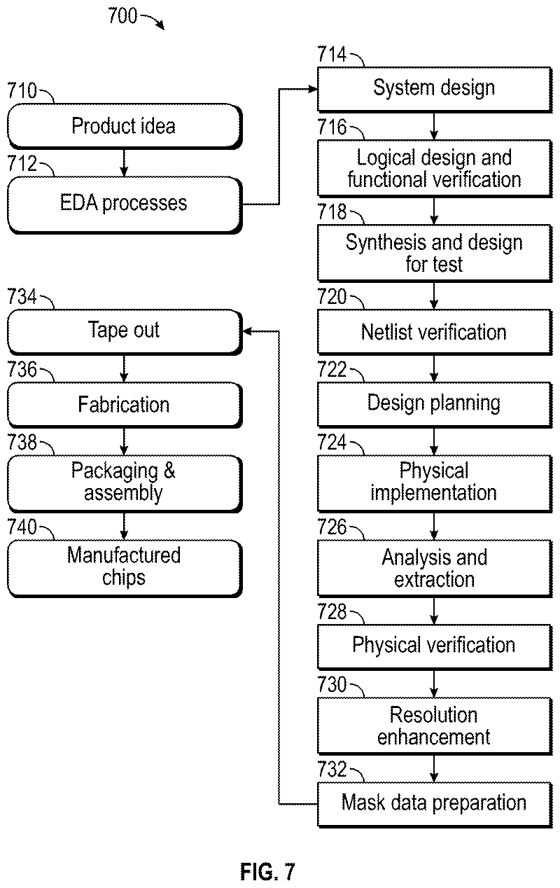

FIG. 7 illustrates an example set of processes 700 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 710 with information supplied by a designer, information which is transformed to create an article of manufacture that uses a set of EDA processes 712. When the design is finalized, the design is taped-out 734, which is when artwork (e.g., geometric patterns) for the integrated circuit is sent to a fabrication facility to manufacture the mask set, which is then used to manufacture the integrated circuit. After tape-out, a semiconductor die is fabricated 736 and packaging and assembly processes 738 are performed to produce the finished integrated circuit 740.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower level representation of a design adds more useful detail into the design description, for example, more details for the modules that include the description. The lower levels representation of a design may be generated by a computer, derived from a design library, or created by another design automation process. An example of a specification language representative of a lower level description of a design is SPICE, which is used for detailed descriptions of circuits with many analog components. Descriptions at each level of representation are enabled for use by the corresponding tools of that layer (e.g., a formal verification tool). A design process may use a sequence depicted in FIG. 7. The processes described by be enabled by EDA products (or tools).

During system design 714, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 716, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 718, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 720, the netlist is checked for compliance with timing constraints and for correspondence with the HDL code. During design planning 722, an overall floor plan for the integrated circuit is constructed and analyzed for timing and top-level routing.

During layout or physical implementation 724, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 726, the circuit function is verified at the layout level, which permits refinement of the layout design. During physical verification 728, the layout design is checked to ensure that manufacturing constraints are correct, such as DRC constraints, electrical constraints, lithographic constraints, and that circuitry function matches the HDL design specification. During resolution enhancement 730, the geometry of the layout is transformed to improve how the circuit design is manufactured.

During tape-out, data is created to be used (after lithographic enhancements are applied if appropriate) for production of lithography masks. During mask data preparation 732, the ‘tape-out’ data is used to produce lithography masks that are used to produce finished integrated circuits.

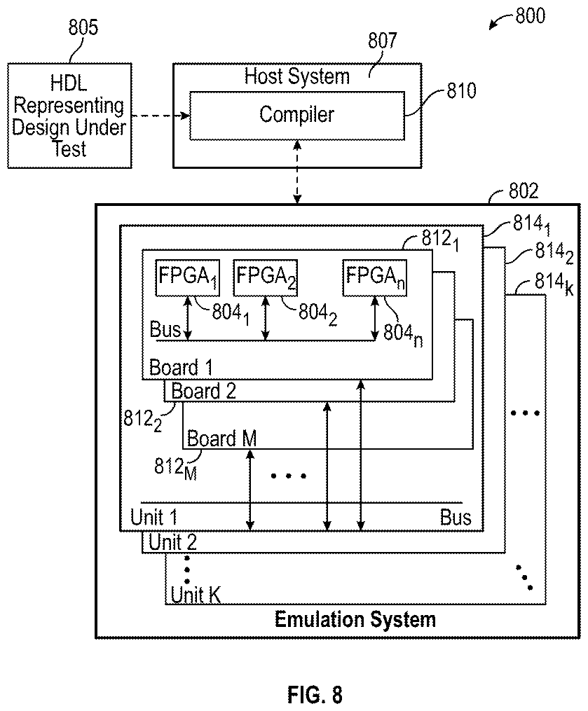

A storage subsystem of a computer system (such as computer system 900 of FIG. 8, or host system 807 of FIG. 7) may be used to store the programs and data structures that are used by some or all of the EDA products described herein, and products used for development of cells for the library and for physical and logical design that use the library.

FIG. 8 depicts a diagram of an example emulation environment 800. An emulation environment 800 may be configured to verify the functionality of the circuit design. The emulation environment 800 may include a host system 807 (e.g., a computer that is part of an EDA system) and an emulation system 802 (e.g., a set of programmable devices such as Field Programmable Gate Arrays (FPGAs) or processors). The host system generates data and information by using a compiler 810 to structure the emulation system to emulate a circuit design. A circuit design to be emulated is also referred to as a Design Under Test (‘DUT’) where data and information from the emulation are used to verify the functionality of the DUT.

The host system 807 may include one or more processors. In the embodiment where the host system includes multiple processors, the functions described herein as being performed by the host system can be distributed among the multiple processors. The host system 807 may include a compiler 810 to transform specifications written in a description language that represents a DUT and to produce data (e.g., binary data) and information that is used to structure the emulation system 802 to emulate the DUT. The compiler 810 can transform, change, restructure, add new functions to, and/or control the timing of the DUT.

The host system 807 and emulation system 802 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 802.11. The host system 807 and emulation system 802 can exchange data and information through a third device such as a network server.

The emulation system 802 includes multiple FPGAs (or other modules) such as FPGAs 804₁ and 804₂ as well as additional FPGAs to 804_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 802 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 804₁-804_{N} may be placed onto one or more boards 812₁ and 812₂ as well as additional boards through 812_{M}. Multiple boards can be placed into an emulation unit 814₁. The boards within an emulation unit can be connected using the backplane of the emulation unit or any other types of connections. In addition, multiple emulation units (e.g., 814₁ and 814₂ through 814_{K}) can be connected to each other by cables or any other means to form a multi-emulation unit system.

For a DUT that is to be emulated, the host system 807 transmits one or more bit files to the emulation system 802. The bit files may specify a description of the DUT and may further specify partitions of the DUT created by the host system 807 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 807 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 807 and/or the compiler 810 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 805 into gate level logic. For a DUT that is to be emulated, the design synthesizer sub-system receives a description of the DUT. If the description of the DUT is fully or partially in HDL (e.g., RTL or other levels of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

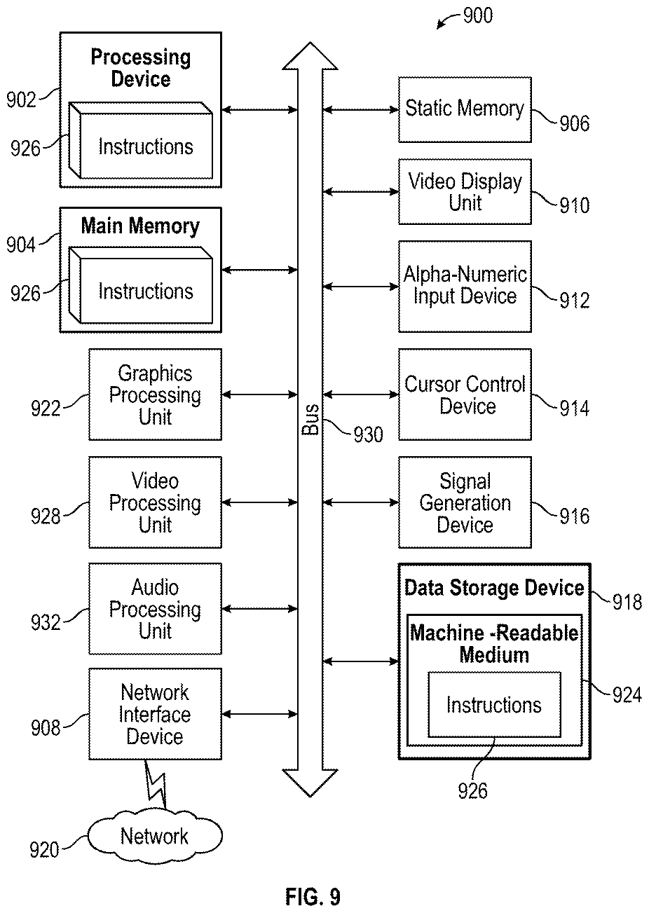

FIG. 9 illustrates an example machine of a computer system 900 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM), a static memory 906 (e.g., flash memory, static random access memory (SRAM), etc.), and a data storage device 918, which communicate with each other via a bus 930.

Processing device 902 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 may be configured to execute instructions 926 for performing the operations and steps described herein.

The computer system 900 may further include a network interface device 908 to communicate over the network 920. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable storage medium 924 (also known as a non-transitory computer-readable medium) on which is stored one or more sets of instructions 926 or software embodying any one or more of the methodologies or functions described herein. The instructions 926 may also reside, completely or at least partially, within the main memory 904 and/or within the processing device 902 during execution thereof by the computer system 900, the main memory 904 and the processing device 902 also constituting machine-readable storage media.

In some implementations, the instructions 926 include instructions to implement functionality corresponding to the present disclosure. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 902 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method of storing data during verification of a circuit design by a hardware emulation system, the method comprising:
receiving, once in every N emulation clock cycles, P sets of register data each set comprising M register bits associated with the circuit design;
storing the M register bits of each set in P shift registers during M cycles of a capture clock; and
shifting out the stored bits during M*P cycles of the capture clock, wherein (M+1)*P is less than or equal to N.

2. The method of claim 1 further comprising:
receiving input data applied to the circuit during one or more emulation cycles; and
storing the received input data in a shift register different from the P shift registers.

3. The method of claim 2 wherein N is equal to one.

4. The method of claim 2 further comprising:
storing the shifted out bits in a local buffer.

5. The method of claim 2 further comprising:
compressing the shifted out bits; and
storing the compressed bits in a local buffer.

6. The method of claim 2 further comprising:
storing the shifted out bits in a local buffer if the shifted out bits are marked as being of interest.

7. The method of claim 4 further comprising:
disposing the data stored in the local buffer in one or more frames; and
delivering the frames to a data storage control logic.

8. The method of claim 2 further comprising:
computing the register data associated with cycles during which the register data are not received from the register data received during cycle N and the received input data, the computed register data being computed by a software simulation tool simulating the circuit design.

9. A non-transitory computer readable medium comprising stored instructions, which when executed by a processor, cause the processor to:
receive, once in every N emulation clock cycles, P sets of register data each set comprising M register bits associated with the circuit design;
store the M register bits of each set in P shift registers during M cycles of a capture clock; and
shift out the stored bits during M*P cycles of the capture clock, wherein (M+1)*P is less than or equal to N.

10. The non-transitory computer readable medium of claim 9 wherein said instructions further cause the processor to:
receive input data applied to the circuit during one or more emulation cycles; and
store the received input data in a shift register different from the P shift registers.

11. The non-transitory computer readable medium of claim 10 wherein N is equal to one.

12. The non-transitory computer readable medium of claim 10 wherein said instructions further cause the processor to:
store the shifted out bits in a local buffer.

13. The non-transitory computer readable medium of claim 10 wherein said instructions further cause the processor to:
compute the register data for (N−1) emulation cycles during which the register data are not received from the register data received during cycle N and the received input data, the processor configured to compute the register data by running a software simulation tool simulating the circuit design.

14. A circuit comprising P shift registers each configured to receive, once in every N emulation clock cycles, P sets of register data each set comprising M register bits, each of the P shift registers further configured to store the M register bits during M cycles of a capture clock and shift out the stored bits during M*P cycles of the capture clock, wherein (M+1)*P is less than or equal to N.

15. The circuit of claim 14 further comprising a shift register, different from the P shift registers, configured to receive and store input data applied to the circuit during one or more emulation cycles.

16. The circuit of claim 14 wherein N is equal to one.

17. The circuit of claim 14 further comprising a local buffer configured to store the shifted out bits.

18. The circuit of claim 14 further comprising:
one or more compression blocks configured to compress the shifted out bits; and
a local buffer configured to store the compressed bits.

19. The circuit of claim 14 further comprising a local buffer configured to store the shifted out bits if the shifted out bits are marked as being of interest.

20. The circuit of claim 18 further comprising:
a frame transmission block configured to convert the data stored in the local buffer to frames, and deliver the frames to a data storage control logic.
